(19) United States
(12) Patent Application Publication
(10) Pub. No.: US 2010/0138424 A1
(43) Pub. Date: Jun. 3, 2010

(54) Methods and Apparatus for the Creation and Editing of Media Intended for the Enhancement of Existing Media

(76) Inventors: Robert Charles Angell, Kent County, RI (US); Ian Mitchell, Newport County, RI (US)

Correspondence Address: RYAN, MASON & LEWIS, LLP, 1300 POST ROAD, SUITE 205, FAIRFIELD, CT, 06824, US

(21) Appl. No.: 12/532,968

(22) PCT Filed: Mar. 28, 2008
(86) PCT No.: PCT/US08/58562

§ 371 Date: Feb. 19, 2010

Related U.S. Application Data
(60) Provisional application No. 60/909,132, filed on Mar. 30, 2007.

(51) Int. Cl. G06F 17/30; G06F 3/048

(52) U.S. Cl. 707/741; 707/705; 707/E17.002; 715/764

(57) ABSTRACT

Methods and apparatus are provided for simplifying the creation and editing of media intended for the enhancement consumer media. A software-based authoring tool is disclosed that allows users to interact directly with and control a DVD or other media format and/or storage medium, specify media content that is intended to enhance the DVD, and output a program and associated media that would be available to other applications to combine with the DVD media. The authoring tool, identified as QC the Interactive Media Enhancement Editor, allows the author to play the DVD5 stop it at certain desired times or events and then allow the author to specify the enhancing media (identified as Secondary Media) that is to be associated with that time or event. The development of Secondary Media content relies on precise coordination with certain events (such as entering a specific menu or chapter of the DVD) or on certain time events (such as 25 seconds into chapter three of the DVD).

### CROSS-REFERENCE TO RELATED APPLICATIONS

This application claims the benefit of U.S. Provisional Application No. 60/909,132, filed Mar. 30, 2007, and is related to United States Provisional Patent Applications entitled “Methods and Apparatus for Distributing Electronic Media Content for the Purpose of Enhancing Existing Media” and “Methods and Apparatus for Distributing Electronic Media Content for the Purpose of Enhancing Existing Media,” each incorporated by reference herein.

### FIELD OF THE INVENTION

The present invention relates to the creation and editing of media content for the purpose of combining the media with other related and pre-existing media content.

### BACKGROUND OF THE INVENTION

There are an ever-increasing number of sources and types of electronic media as various technologies advance. Types of electronic media include, but are not limited to, text, image, animations, movies of various formats, games, interactive applications, etc. Sources of electronic media include optically recorded media (such as CD, DVD, HD DVD and Blue-Ray), the Internet, magnetic storage devices and electronic storage devices. Other than the limited abilities of the Personal Computer in this area, there are few choices available to consumers to effectively combine or overlay multiple media sources for enhanced viewing.

A need exists for methods and apparatus that temporarily combine Secondary Media and DVD content for display purposes.

### SUMMARY OF THE INVENTION

Generally, methods and apparatus are provided for simplifying the creation and editing of media intended for the enhancement consumer media. A software-based authoring tool is disclosed that allows users to interact directly with and control a DVD or other media format and/or storage medium, specify media content that is intended to enhance the DVD, and output a program and associated media that would be available to other applications to combine with the DVD media. The authoring tool, identified as the Interactive Media Enhancement Editor (IMEE) for this presentation, will allow the author to play the DVD, stop it at certain desired times or events and then allow the author to specify the enhancing media (identified as Secondary Media for this presentation) that is to be associated with that time or event. Examples of Secondary Media include trivial pursuit type interaction, graphic overlays, additional sound and interactive games. Once the Secondary Media has been identified and associated with the current state of the DVD, the IMME application will generate and output the appropriate software and media for later use by applications that combine original DVD content with Secondary Media content.

The development of Secondary Media content relies on precise coordination with certain events (such as entering a specific menu or chapter of the DVD) or on certain time events (such as 25 seconds into chapter three of the DVD). It is often a tedious process of trial and error to create a visually pleasing and acceptable combination of Secondary Media and DVD media. The IMME application is intended to remove this painstaking approach to developing the Secondary Media by directly associating an author's content to the current state of the DVD and outputting all the required information in a format that could later be translated into a format that will be useful to technologies that temporarily combine these media types for display.

According to one aspect of the invention, IMME is a software application that interfaces with the DVD controller of a computer, storage devices of that computer, and the author that is creating the Secondary Media. The IMME interface to the DVD controller includes controlling the DVD device and receiving updates from the device indicating its current state and the state of the DVD. The IMME will display the content of DVD as it plays and will allow the operator to finely control the DVD. When the DVD is paused for enhancement, the IMME will prompt the author to specify the enhancement content. This could be an image to overlay, trivia questions, an application file execute, a sound track to play, etc. More than one enhancement could be associated with a DVD event. They could be specified to be sequential or simultaneous or a combination. Once the Secondary Media is specified the IMME will output the appropriate media information and the state of the DVD in a manner that can later be reformatted for various applications.

Advantages of the present invention include simplifying the authoring of Secondary Media as well as creating generic output of the information required to combine the Secondary Media and the DVD media. This generic output could later be processed and formatted in a way that would be usable by various technologies associated with combining media from multiple sources for display. In this manner, content providers can give consumers added value to their media in the form of games, applications, amplifying information and on-line communities. It will also allow content providers to offer additional marketing-related information to consumers.

A more complete understanding of the present invention, as well as further features and advantages of the present invention, will be obtained by reference to the following detailed description and drawings.

### BRIEF DESCRIPTION OF THE DRAWINGS

FIG. 1 is a block diagram of the Interactive Media Enhancement Editor in accordance with an embodiment of the present invention;

FIG. 2 is a flow diagram representing the Media Author interaction with the IMEE; and

FIG. 3 is a sample table from an exemplary multi-media overlay index incorporating features of the present invention.

### DETAILED DESCRIPTION

Detailed embodiments of the present invention are disclosed herein, however, it is to be understood that the disclosed embodiments are merely exemplary of the invention, which may be embodied in various forms. Therefore, specific functional or structural details disclosed herein are not to be interpreted as limiting, but merely as a basis for the claims and as a representative basis for teaching one skilled in the art to variously employ the present invention in virtually any appropriately detailed embodiment.

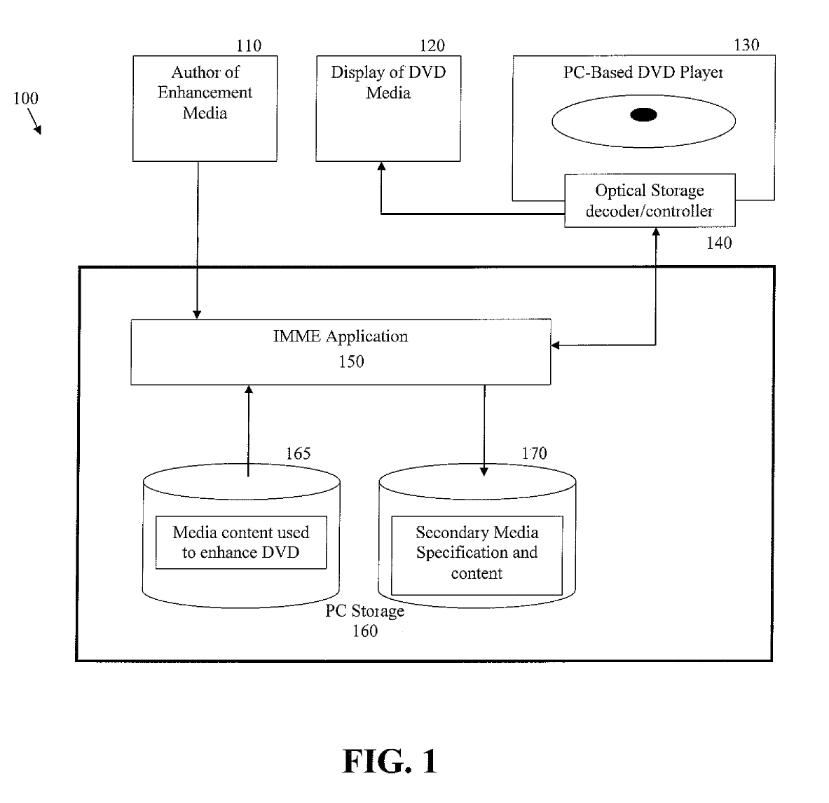

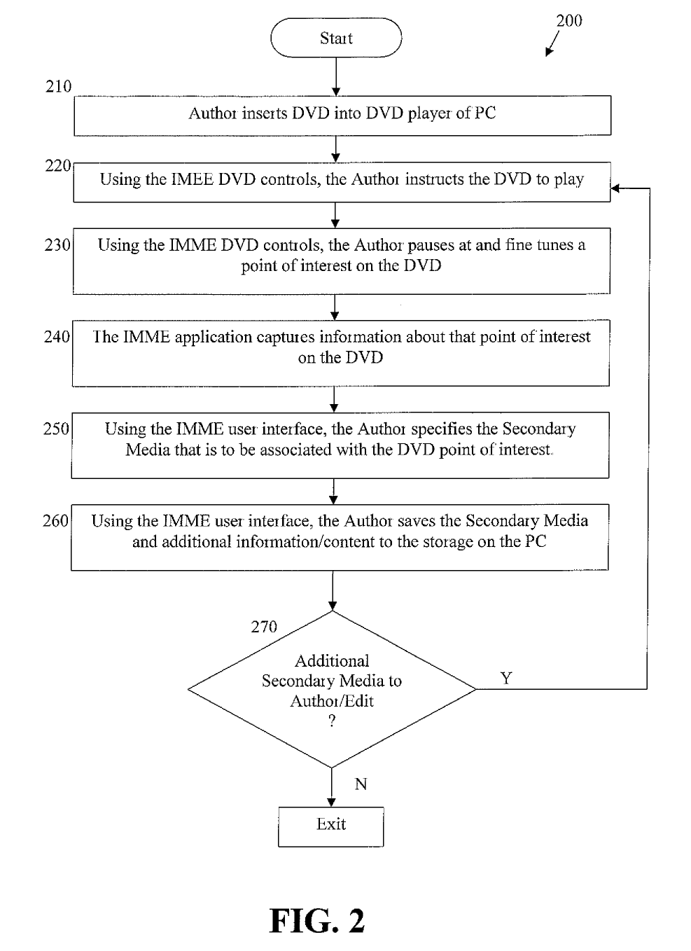

Turning now to FIG. 1, a block diagram of an exemplary embodiment of the present invention is shown. As shown in FIG. 1, an Interactive Media Enhancement Editor system 100 comprises the IMME application 150, a computing device 130, such as a personal computer with a DVD player, and an interface for Authors 110 that create Secondary Media to be associated with DVD Media. FIG. 1 shows the interaction between the Authors 110 and the IMEE application 150 and the interaction between the IMEE application 150 and DVD Player 130, in a manner discussed further below in conjunction with FIG. 2. Further, FIG. 1 shows the interaction of the IMEE application 150 with the storage 160 of the PC. The PC storage 160 contains a database 165 for accessing media to associate with the DVD media and a database 170 to store the Secondary Media and its associated information (such as type of content, time or event on DVD to associate and combine with, and duration of combination). FIG. 1 also shows the DVD decoder/controller 140 sending its output to the display 120.

FIG. 2 is a flow diagram 200 representing exemplary Media Author interactions with the IMEE 100. Authors insert a DVD of interest into the player during step 210 and, using the IMEE controls, start to play the DVD during step 220. When an event of interest occurs on the DVD, the Author can pause (and further fine tune the pause) during step 230. During step 240, the IMME application captures information about the identified point of interest on the DVD (such as menus, chapter, and time into chapter).

During step 250, the Author, using the IMME graphical user interface, specifies the Secondary Media to be combined with that point on the DVD. Part of specifying the Secondary Media could include locating the specific content files (such as images, scripts, sounds and text), likewise the author may simply type his or her own content (such as a trivia question, the answer, and distracters). Once the Secondary Media has been located and specified, the Author saves it off to storage. The state of the DVD is also stored. The information will be in a generic format so that it can be converted for use by various applications that might combine primary and secondary media for display.

During step 260, the Author saves the Secondary Media and additional information/content to the storage on the PC. A test is performed during step 270 to determine if there is additional Secondary Media to be authored or edited. If there is no additional Secondary Media, program control terminates.

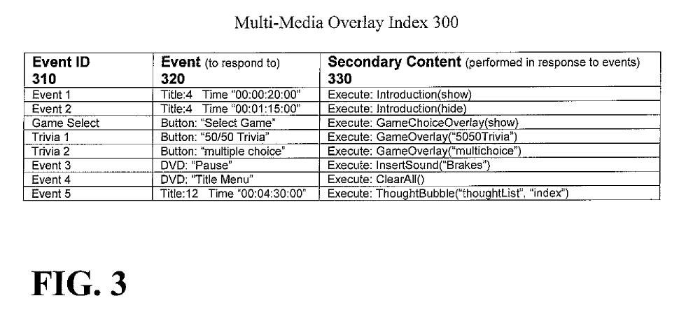

FIG. 3 is a sample table from an exemplary multi-media overlay index 300 incorporating features of the present invention. As shown in FIG. 3, the exemplary multi-media overlay index 300 is associated with a particular primary content item, such as a particular movie or a particular episode of a television show. The exemplary multi-media overlay index 300 comprises a plurality of records, each associated with a different event in the primary content. For each event identified in field 310, the exemplary multi-media overlay index 300 defines the event in the field 320 and identifies the secondary content associated with the event in field 330.

The exemplary multi-media overlay index 300 allows particular secondary content to be associated with desired times or events in the primary content. Examples of secondary content include trivial pursuit type interaction, graphic overlays, additional sound and interactive games.

While FIG. 2 shows an exemplary sequence of steps, it is also an embodiment of the present invention that the sequence may be varied. Various permutations of the algorithm are contemplated as alternate embodiments of the invention.

While exemplary embodiments of the present invention have been described with respect to processing steps in a software program, as would be apparent to one skilled in the art, various functions may be implemented in the digital domain as processing steps in a software program, in hardware by circuit elements or state machines, or in combination of both software and hardware. Such software may be employed in, for example, a digital signal processor, micro-controller, or general-purpose computer. Such hardware and software may be embodied within circuits implemented within an integrated circuit.

Thus, the functions of the present invention can be embodied in the form of methods and apparatuses for practicing those methods. One or more aspects of the present invention can be embodied in the form of program code, for example, whether stored in a storage medium, loaded into and/or executed by a machine, or transmitted over some transmission medium, wherein, when the program code is loaded into and executed by a machine, such as a computer, the machine becomes an apparatus for practicing the invention. When implemented on a general-purpose processor, the program code segments combine with the processor to provide a device that operates analogously to specific logic circuits. The invention can also be implemented in one or more of an integrated circuit, a digital signal processor, a microprocessor, and a micro-controller.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

What is claimed is:

1. An apparatus for authoring supplemental content related to one or more primary content items, comprising:
a memory; and
at least one processor, coupled to the memory, operative to:
identify a point of interest in one or more of said primary content items;
obtain information about said point of interest; and
receive a specification of said supplemental content associated with said point of interest.

2. The apparatus of claim 1, wherein said information comprises one or more of menus, chapters and time stamp information about said point of interest.

3. The apparatus of claim 1, wherein said primary content items are obtained from one or more of a CD, DVD or streaming media connection.

4. The apparatus of claim 1, wherein said supplemental content is presented to said user based on or more of a schedule, a timeline, user control actions and events in said primary content.

5. The apparatus of claim 1, wherein said specification links said supplemental content to said point of interest in said one or more primary content items.

6. The apparatus of claim 1, wherein said supplemental content is overlayed on said one or more primary content items based on said specification.

7. The apparatus of claim 1, further comprising an interface to allow an author to interact with one or more of said supplemental content and said one or more primary content items.

8. The apparatus of claim 1, wherein said processor is further configured to generate an overlay index that associates said supplemental content with one or more times or events in said primary content.

9. A method for authoring supplemental content related to one or more primary content items, comprising:
identifying a point of interest in one or more of said primary content items;
obtaining information about said point of interest; and
receiving a specification of said supplemental content associated with said point of interest.

10. The method of claim 9, wherein said information comprises one or more of menus, chapters and time stamp information about said point of interest.

11. The method of claim 9, wherein said primary content items are obtained from one or more of a CD, DVD or streaming media connection.

12. The method of claim 9, wherein said supplemental content is presented to said user based on or more of a schedule, a timeline, user control actions and events in said primary content.

13. The method of claim 9, wherein said specification links said supplemental content to said point of interest in said one or more primary content items.

14. The method of claim 9, wherein said supplemental content is overlayed on said one or more primary content items based on said specification.

15. The method of claim 9, further comprising an interface to allow an author to interact with one or more of said supplemental content and said one or more primary content items.

16. The method of claim 9, further comprising the step of generating an overlay index that associates said supplemental content with one or more times or events in said primary content.

17. An article of manufacture for authoring supplemental content related to one or more primary content items, comprising a machine readable storage medium containing one or more programs which when executed implement the steps of:
identifying a point of interest in one or more of said primary content items;
obtaining information about said point of interest; and
receiving a specification of said supplemental content associated with said point of interest.

18. The article of manufacture of claim 17, wherein said information comprises one or more of menus, chapters and time stamp information about said point of interest.

19. The article of manufacture of claim 17, wherein said supplemental content is presented to said user based on or more of a schedule, a timeline, user control actions and events in said primary content.

20. The article of manufacture of claim 17, further comprising the step of generating an overlay index that associates said supplemental content with one or more times or events in said primary content.
